(19) United States
(12) Patent Application Publication
(10) Pub. No.: US 2021/0155273 A1
(43) Pub. Date: May 27, 2021

(54) LIGHT WEIGHT AND LOW F NUMBER LENS AND METHOD OF PRODUCTION

(71) Applicant: RAIL VISION LTD, Ra'anana (IL)

(72) Inventors: Yuval ISBI, Nes Ziona (IL); Shahar HANIA, Kedumim (IL); Alan GELLER, Kadima (IL)

(73) Assignee: RAIL VISION LTD, Ra'anana (IL)

(21) Appl. No.: 16/965,366

(22) PCT Filed: Jan. 28, 2019
(86) PCT No.: PCT/IL2019/050111

§ 371 Date: Jul. 28, 2020

Related U.S. Application Data
(60) Provisional application No. 62/623,037, filed on Jan. 29, 2018.

(51) Int. Cl. B61L 23/04; G01J 5/08; G02B 13/14

(52) U.S. Cl. CPC B61L 23/041; G01J 2005/0077; G02B 13/14; G01J 5/0806

(57) ABSTRACT

Generally, an optical unit for collecting light from small and/or distant objects is disclosed. The optical unit may include a front lens having a diameter of at least 150 mm and at least one additional lens in association with the front lens, wherein the front lens is made of chalcogenide glass. In some embodiments, a weight of the optical unit ranges between 2 and 6 kg.

### FIELD OF THE INVENTION

The present invention relates to the field of low f-number lens, and more particularly, to low f-number lens for collecting light from small and/or distant objects.

### BACKGROUND OF THE INVENTION

Current optical units for collecting light from small and distant objects are typically heavy and of large size. This is even more so when the optical unit is designed to withstand large operational temperature range.

For example, FIG. 1 shows typical current optical unit 90 for collecting light from small and distant objects. Optical unit 90 consists of a front lens 92 (optionally with a correction optical element 94) and additional optical elements 96.

Typically, front lens 92 (or an aperture) of optical unit 90 for collecting light from small and distant objects has relatively large diameter of at least 150 mm. If optical unit 90 has to withstand relatively wide operational temperature range (e.g., of tens degrees of Celsius) then front lens 92 of current optical units 90 are typically made of Germanium, as Germanium-made front lens 92 may be adapted to provide steady optical performance in relatively wide range of temperatures.

As Germanium is relatively heavy crystal (e.g., atomic mass of 72.63 u), current optical units 90 for collecting light from small and distant objects are heavy. For example, optical unit 90 shown in FIG. 1 having front lens 92 with the diameter ranging between 150-300 mm made of Germanium may weigh between about 10-29 kg. Such heavy optical units 90 may significantly limit the number of applications in which current optical units 90 may be utilized and/or make the utilization of current optical units 90 complex and/or expensive.

Moreover, Germanium-made lens (e.g., such as first lens 92 of optical unit 90) alone cannot provide fully passive steady optical performance in wide temperatures range (e.g., such as −30°−55° C.), for example due to tolerances thereof. Thus, current optical units 90 that utilize Germanium-made lens (e.g., such as front lens 92) may require additional mechanical means (e.g., one or more motors) adapted to move one or more of lens components in order to compensate for the thermal instability of the thereof.

### SUMMARY OF THE INVENTION

One aspect of the present invention provides an optical unit for collecting light from small or distant objects, the optical unit may include a front lens having a diameter of at least 150 mm and at least one additional lens in association with the front lens, wherein the front lens is made of chalcogenide glass.

In some embodiments, the optical unit has a weight ranging between 2-6 kg.

In some embodiments, the optical unit has an f-number of no more than 1.4.

In some embodiments, the optical unit has a focal length of no more than 150 mm.

In some embodiments, the the front lens has a rate of change of a refractive index of no more than 55 1/° C.

Another aspect of the present invention provides a system for detection and identification of a small or distant object by a moving train, the system may include: an optical unit comprising a front lens having a diameter of at least 150 mm and made of chalcogenide glass, and at least one additional lens in association with the front lens; a detector is association with the optical unit, wherein the optical unit is arranged to collect light from the small or distant object onto the detector and wherein the detector is arranged to generate at least one image based on the collected light; and a processing unit coupled to the detector and configured to identify rails in the at least one image and to identify, in the at least one image, the small or distant object on the rails or in a defined vicinity of the rails.

In some embodiments, the optical unit has a weight ranging between 2-6 kg.

In some embodiments, the optical unit has an f-number of no more than 1.4.

In some embodiments, the optical has a focal length of no less than 150 mm.

In some embodiments, the front lens of the optical unit has a rate of change of a refractive index of no more than 55 1/° C.

In some embodiment, the detector is an infrared camera.

In some embodiments, the system is installable on a locomotive of the train such that the optical unit and the detector face a direction of travel of the train.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIG. 1 shows typical current optical unit for collecting light from small and distant objects;

FIG. 2 is a schematic illustration of a system for an obstacle detection and identification by a moving train, according to some embodiments of the invention; and

FIG. 3 is a schematic illustration of an optical unit for collecting light from small and/or distant objects, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

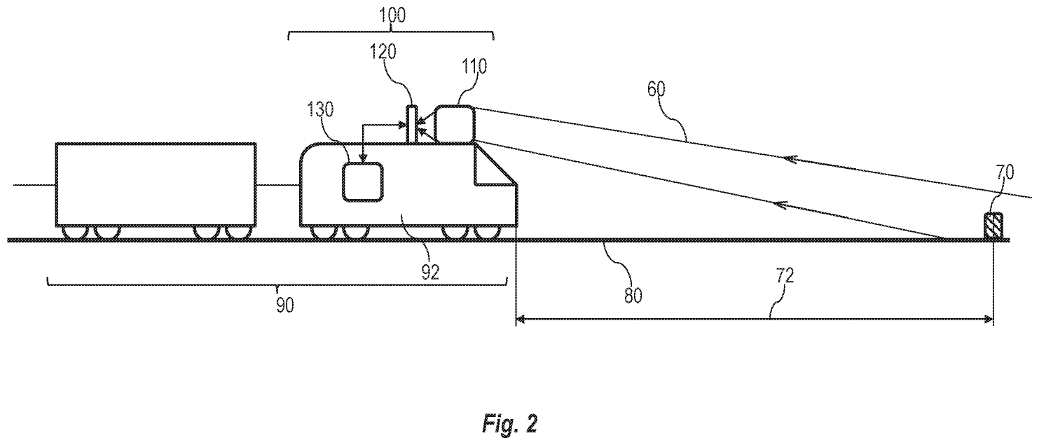

Reference is now made to FIG. 2, which is a schematic illustration of a system 100 for an obstacle detection and identification by a moving train 90, according to some embodiments of the invention.

According to some embodiments, system 100 includes an optical unit 110 in association with a detector 120 and a processing unit 130 coupled to detector 120. System 100 may be disposed on, for example, a locomotive 92 of train 90 such that optical unit 110 and detector 120 face the direction of travel of train 90.

Optical unit 110 may collect light 60 from an environment onto detector 120. Detector 120 (e.g., infrared camera) may generate images of the environment based on the collected light. Processing unit 130 may be configured to analyze the images generated by detector 120 and identify rails 80 in the images (e.g., based on an inherent difference of temperature between rails 80 and the environment) and/or identify a potential object/obstacle 70 on rails 80 or in a defined vicinity of rails 80 (e.g., based on a difference of temperature between object/obstacle 70, rails 80 and the environment).

The required performance of system 100 should ensure detection and identification of small and/or distant objects/obstacles 70 on rails 80 and in vicinity of rails 80 well in advance so as to enable safe braking of train 90 before it reaches object/obstacle 70, when an accident with object/obstacle 70 has been detected by processing unit 130.

For example, for train 90 travelling at a speed of 150 km/h, a detection and identification distance 72 of potential object/obstacle 70 on rails 80 should be about 2 km and/or system 100 has to be capable of detecting and identifying objects/obstacles 70 of about 0.5 m width.

The required performance of system 100 should further ensure steady optical performance within a specified range of ambient temperatures. For example, system 100 has to steadily and robustly perform within ambient temperature ranging between −35°−55° C.

In order to fulfil the abovementioned requirements, optical unit 110 of system 100 has to be capable of efficiently collecting light from small and/or distant objects 70 within the specified temperature range (e.g., as described above).

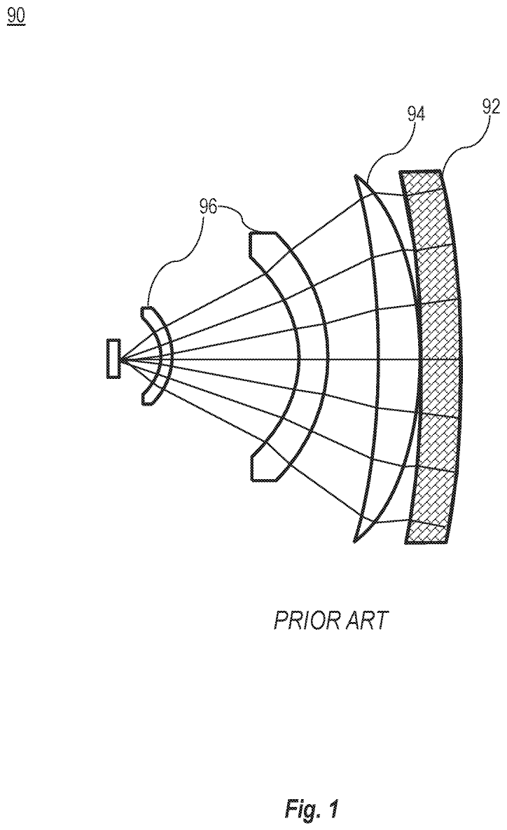

Current optical units (e.g., optical unit 90 described above with respect to FIG. 1) for collecting light from small and/or distant objects and designed to operate within such wide range of ambient temperatures typically utilize front lens made of Germanium and thus are relatively heavy. For example, the weight of current optical unit 90 capable of fulfil the abovementioned requirement for system 100 may range between 10-29 kg (e.g., as described above with respect to FIG. 1).

However, such heavy optical units (e.g., as current optical unit 90) may be subjected to large acceleration forces, movements and vibrations during the motion of train 90, which may reduce the efficiency of detection and identification of small and/or distant objects/obstacles 70 by system 100. As a result, such heavy optical units (e.g., as current optical unit 90) may require more complex and expensive stabilizing and aiming means in order to compensate for the motion and vibration artifacts thereof.

Moreover, Germanium-made lens (e.g., such as first lens 92 of optical unit 90) may require that the optical unit (e.g., optical unit 90) will include mechanical means (e.g., one or more motors) adapted to move one or more of lens components in order to compensate for the thermal instability of the lens and to provide steady optical performance in the required range of temperatures. This may, for example, further increase the overall cost and complexity of the optical unit.

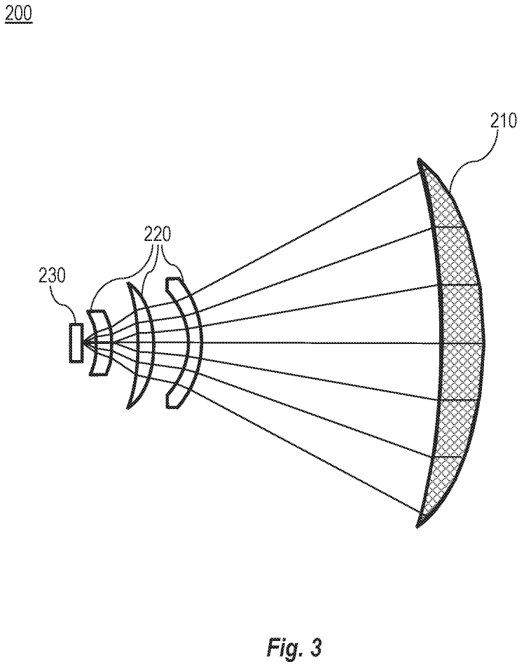

Accordingly, this leads to an effort of developing specially designed optical unit 110 capable of fulfilling the abovementioned requirements for system 100 (e.g., as described below with respect to FIG. 3).

Reference is now made to FIG. 3, which is a schematic illustration of an optical unit 200 for collecting light from small and/or distant objects, according to some embodiments of the invention.

According to some embodiments, optical unit 200 is used as optical unit 110 in system 100 for the obstacle detection and identification by the moving train (e.g., as described above with respect to FIG. 2).

According to some embodiments, optical unit 200 includes a front lens 210 and one or more additional lens 220 in association with front lens 210 (e.g., as shown in FIG. 3).

Optical unit 200 may be arranged to collect light from small and/or distant objects onto a detector 230 (e.g., such as infrared camera 120 described above with respect to FIG. 2).

The inventors have found that in order to efficiently collect light from small and/or distant objects (e.g., such as object/obstacle 70 of about 50 cm width at distance 72 of about 2 km from the optical unit, as described above with respect to FIG. 2) within an extended environment scene, optical unit 200 has to be arranged to provide a desired optical amplification of the small and/or distant object. For example, optical unit 200 may be arranged to provide a desired intensity/irradiance of the light collected from the small and/or distance object together with the light collected from the extended environment scene.

For example, the irradiance collected by optical unit 200 from the extended environment scene (interchangeably referred hereinafter as “extended source”, Eₑₛ) and from the small and/or distant object (interchangeably referred hereinafter as “point-source”, Eₚₛ) at a plane of detector 230, may be based on an f-number, F/#, of optical unit 200, for example as shown in Equation 1 and Equitation 2, respectively:

$$\begin{matrix}{E}_{e s} = \frac{π L}{4 {( F / \# )}^{2} + 1} & ( Equation 1 ) \\ {E}_{p s} = \frac{0.84 I {Ω}_{o p t}}{\frac{π}{4} ( 2.44 {λ ( F / \# )}^{2} )} & ( Equation 2 )\end{matrix}$$

where L is a radiance (e.g., in units of W/cm²·steradian), I is a radiant intensity (e.g., in untis of W/steradian), Ωₒₚₜ is a solid angle and λ is a wavelength (e.g., in units of cm).

For example, for optical unit 200 with the f-number of 2 (e.g., F/2) the value of the dominator for Eₑₛ is 101 and the value of dominator for Eₚₛ is 25, which provides the optical amplification of about 4 for the point source (e.g., for the small and/or distant object). In this manner, for optical unit 200 with the f-number of 0.8 (e.g., F/0.8) the optical amplification value for the point source is 5.5. Thus, the smaller the f-number F/# of optical unit 200, the higher the optical amplification and the relative amplification of the point source with respect to the extended source that may be provided by optical unit 200.

Accordingly, the smaller the f-number, F/#, and the larger the focal length, f, of optical unit 200, the greater efficiency of optical unit 200 with respect to collecting light from the small and/or distant object.

In some embodiments, the f-number of optical unit 200 is no more than 1.4. For example, the f-number of optical unit 200 ranges between 0.75-1.2.

In some embodiments, the focal length, f, of optical unit 200 is no more than 150 mm.

Such small f-numbers (e.g., F/#) and such large focal lengths (e.g., f) may require that front lens 210 of optical unit 200 will have relatively large diameter. For example, the diameter of front lens 210 of optical unit 200, D_{1st_lens}, may be based on the f-number, F/#, and the focal length, f, of optical unit 200, as follows:

$${D}_{1 st\_lens} = \frac{f}{F / \#} \qquad ( Equation 3 )$$

For example, if optical unit 200 has the f-number of 1 (e.g., F/1) and the focal length of 250 mm (e.g., f=250 mm), the dimeter of front lens 210 should be 250 mm (e.g., D_{1st_kns}=250 mm).

In some embodiments, the diameter of front lens 210 of optical unit 200 ranges between 100-300 mm.

In some embodiments, optical unit 200 needs to maintain a steady optical performance in a specified temperature range. For example, when optical unit 200 is used in system 100 for the obstacle detection and identification by the moving train, optical unit 200 has to steadily perform in the temperature range of at least −30°−55° C. (e.g., as described above with respect to FIG. 2).

The optical performance of optical unit 200 may, for example, include a rate of change of a refractive index of front lens 210 of optical system 200 as function the ambient temperature. The smaller the change of the refractive index of front lens 210 of optical unit 200 as function the ambient temperature the steadier the optical performance of optical unit 200.

In some embodiments, front lens 210 of optical unit 200 is made of chalcogenide glass (e.g., glass containing one or more of chalcogens such as sulfur, selenium and tellurium). For example, front lens 210 may be made of GASIR®1 or GASIR®5 glass.

The inventors have found that making front lens 210 of optical unit 200 of chalcogenide glass improves the optical performance and significantly reduces the weight of optical unit 200/front lens 210 as compared to current optical units 90 having front lens 92 may of Germanium (e.g., as described above with respect to FIG. 1).

For example, the rate of change of the refractive index of front lens 210 of optical unit 200 made of chalcogenide glass may range between 32 and 55 1/° C. (at wavelength of 10 μm) while the rate of change of the refractive index of front lens 92 of current optical unit 90 made of Germanium may be 396 1/° C. (at wavelength of 10 μm).

Furthermore, the weight optical unit 200 having front lens 210 made of chalcogenide glass may range between 2-6 kgs while the weight of current optical unit 90 having front lens 92 made of Germanium and having the same f-number, focal length the diameter of front lens as optical unit 200 may range between 10-29 kg.

Moreover, front lens 210 of optical unit 200 made of chalcogenide glass may provide passive compensation of the thermal instability of the lens, thereby providing steady optical performance of optical unit 200 while eliminating a need in complex and expensive mechanical means for compensating the thermal instability thereof (e.g., as may be required in current optical units 90 utilize Germanium-made first lens 92, as described above with respect to FIG. 1).

Advantageously, selecting the use of chalcogenide glass for large apertures/front lens of, for example, above 200 mm (such as front lens 210 of optical unit 200, as described above with respect to FIG. 3), which was not done ever before for this purpose, dramatically reduces the weight of the front lens and of the entire optical unit and provides an improved thermal stability as compared to current optical units having large apertures/front lens made of, for example, Germanium (such as current optical unit 90 described above with respect to FIG. 1).

For example, the disclosed optical unit (such as optical unit 200 described above with respect to FIG. 3) may be used in the system for the obstacle detection and identification by the moving train (such as system 100 described above with respect to FIG. 2). Advantageously, the disclosed optical unit may significantly reduce the acceleration forces and vibrations experienced by the optical unit during the motion of the train, thereby significantly improve the efficiency of detection and identification of the small and/or distant objects/obstacles by the system as compared to current optical units (such as optical units 90 as described above with respect to FIG. 1).

Furthermore, the disclosed optical unit may significantly reduce the complexity and/or cost of stabilizing and aiming means for the optical unit thereof (e.g., as compared to those required for current optical units 90 described above with respect to FIG. 1), thereby significantly reducing the overall complexity and costs of the system.

Moreover, the disclosed optical unit may provide passive compensation of the thermal instability of the lens (e.g., due to first lens 210 made of chalcogenide glass, as described above with respect to FIG. 3) thereby eliminating a need in complex and expensive mechanical means for compensating the thermal instability thereof (e.g., as may be required in current optical units 90 utilize Germanium-made first lens 92, as described above with respect to FIG. 1). Thus, the disclosed optical unit may further significantly reduce the overall complexity and cost of the system. Such optical units (e.g., optical unit 200 as described above with respect to FIG. 3) and having passive thermal compensation (g., due to first lens 210 made of chalcogenide glass, as described above with respect to FIG. 3) may be more reliable when installed on the train as compared to current optical systems (e.g., such as optical system 90 as described above with respect to FIG. 1).

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. An optical unit for collecting light from small or distant objects, the optical unit comprising:
a front lens; and
at least one additional lens in association with the front lens;
wherein the front lens is made of chalcogenide glass.

2. The optical unit of claim 1 having a weight ranging between 2-6 kg.

3. The optical unit of claim 1 having an f-number of no more than 1.4.

4. The optical unit of claim 1 having a focal length of no more than 150 mm.

5. The optical unit of claim 1, wherein the front lens has a rate of change of a refractive index of no more than 55 1/° C.

6. A system for detection and identification of a small or distant object by a moving train, the system comprising:
an optical unit comprising a front lens made of chalcogenide glass, and at least one additional lens in association with the front lens;
a detector is association with the optical unit, wherein the optical unit is arranged to collect light from the small or distant object onto the detector and wherein the detector is arranged to generate at least one image based on the collected light; and
a processing unit coupled to the detector and configured to identify rails in the at least one image and to identify, in the at least one image, the small or distant object on the rails or in a defined vicinity of the rails.

7. The system of claim 6, wherein the optical unit has a weight ranging between 2-6 kg.

8. The system of claim 6, wherein the optical unit has an f-number of no more than 1.4.

9. The system of claim 6, wherein the optical unit has a focal length of no less than 150 mm.

10. The system of claim 6, wherein the front lens of the optical unit has a rate of change of a refractive index of no more than 55 1/° C.

11. The system of claim 6, wherein the detector is an infrared camera.

12. The system of claim 6, installable on a locomotive of the train such that the optical unit and the detector face a direction of travel of the train.

13. The optical unit of claim 1, wherein a diameter of the front lens ranges between 100-300 mm.

14. The optical unit of claim 6, wherein a diameter of the front lens ranges between 100-300 mm.
